(19) United States
(12) Patent Application Publication
(10) Pub. No.: US 2005/0151052 A1
(43) Pub. Date: Jul. 14, 2005

(54) Dual three-spots optical scanning device

(75) Inventors: Petrus Theodorus Jutte, Eindhoven (NL); Peter Coops, Eindhoven (NL); Ronald Reindert Drenten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/499,625

(22) PCT Filed: Dec. 18, 2002
(86) PCT No.: PCT/IB02/05621

(30) Foreign Application Priority Data
Dec. 24, 2001 (EP) 01205082.9

(51) Int. Cl. G02B 7/04

(52) U.S. Cl. 250/201.5

(57) ABSTRACT

A radiation detector array for radial tracking error detection for a dual-wavelength optical scanning device. Three spot detectors (100, 102, 104) for conducting three spot radial tracking error detection at each of the two different wavelengths. Satellite spot detectors (102, 104) are divided into three detector elements and one switched depending on the wavelength currently being used for scanning.

This invention relates to a dual optical scanning device for scanning optical record carriers with any one of two different wavelengths, the device comprising a radiation detector array for performing scanning error detection, and to such a radiation detector array.

Currently, scanning devices using two-wavelength laser devices are being studied. Typically, the scanning devices use a common beam path for both wavelengths and the two wavelengths are joined after emission from different parts of the laser device, for example by means of a diffraction grating. There is a need to perform scanning error detection for both wavelengths.

Typical scanning error detection methods used in optical disk scanning devices are focus error detection and tracking error detection. Various different methods are known for focus error detection and radial tracking error detection. The focus error detection methods include knife edge pupil obscuration, in which the beam is split into two by e.g. a prism and the position of the spots on two spot detectors indicate correct focusing; astigmatic focusing, in which an astigmatic spot on the detector is created by means of a cylindrical lens or a plane parallel plate, and variations in the shape of the spot from circular are detected by a diamond-shaped quadrant spot detector; and spot size detection, in which the beam is separated into two by e.g. a microprism and detecting the resulting spot sizes before and after refocusing respectively.

Radial tracking error detection methods include push-pull radial tracking, in which a difference in signal between two pupil halves are measured on separate detectors; three spot (or three beam) central aperture radial tracking, in which the radiation beam is split into three by a diffraction grating, and the outer (satellite) spots are set a quarter track pitch off the main spot and the difference of their signals used to generate the tracking error signal; three spots push-pull radial tracking, in which the radiation beam is split into three by a diffraction grating and a difference between the push-pull signals of the main spot and the satellite spots is used as the tracking error signal; and Differential Phase or Time Detection (DPD or DTD) radial tracking, in which the contribution of the radial offset of the phase of the (±1, ±1) orders is exploited in a square-shaped quadrant spot detector. The three spot push-pull radial tracking system has the advantage over one spot push-pull systems is that systematic errors, including symmetric errors and asymmetric errors, may be compensated for automatically. However, the system requires additional detector elements and connections, increasing the complexity of the detector array.

European patent application EP-A-0860819 describes an optical scanning device which uses two lasers with different wavelengths and a common objective lens to produce spots suitable for reading low density as well as high density disks. Various different detector array arrangements are proposed for detecting focus error and tracking error during scanning. In one embodiment, two separate detector arrays are used for each separate wavelength. In another embodiment, a single detector array is used for each wavelength. The array includes two detector elements for three beam tracking error detection at the longer of the wavelengths, whereas single beam tracking is used at the shorter wavelength.

If in scanning device, which uses two wavelengths a single detector array is used for push-pull tracking error detection, the problem arises that if the spacing between the n^{th} order spot detectors is correct for one of the wavelength, these detectors can not be used to detect the n^{th} order spots for the other wavelength with sufficient accuracy.

It is an object of the present invention to provide a solution for this problem. In accordance with one aspect of the present invention there is provided a radiation detector array for radial tracking error detection when scanning optical record carriers with two wavelengths, said array comprising a plurality of spot detectors for detecting first and second groups of radiation beams forming respectively first and second sets of spots corresponding to different diffractive orders including a zeroth order and plus and minus n^{th} order, n being an integer of 1 or more, each said spot detector being arranged to detect a characteristic of a spot formed by a said beam and each said spot detector comprising a plurality of detector elements for detecting different parts of a said spot, said array comprising a zeroth order spot detector arranged substantially centrally and n^{th} order spot detectors arranged to each side thereof, wherein said n^{th} order spot detectors are arranged to perform radial tracking error detection for a first set of spots in which the n^{th} order spots have a first predetermined spacing characteristic with respect to the zeroth order spot and for a second set of spots in which the n^{th} order spots have a second, different predetermined spacing characteristic with respect to the zeroth order spot.

In accordance with a second aspect of the invention, there is provided a dual optical scanning device, using two wavelengths, comprising a radiation detector array as described.

Further aspects and advantages of the invention will become apparent from the following description of preferred embodiments of the invention, made with reference to the accompanying drawings, wherein:

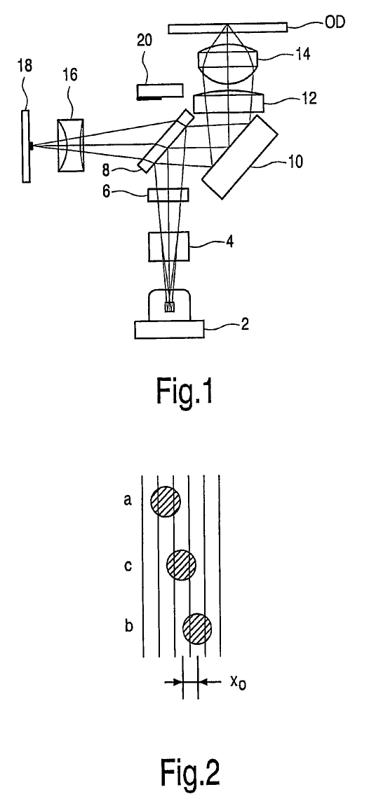

FIG. 1 is a schematic plan view of an optical scanning device arranged in accordance with embodiments of the invention;

FIG. 2 is a schematic plan views of three spots focused on conventional data tracks of an optical disk;

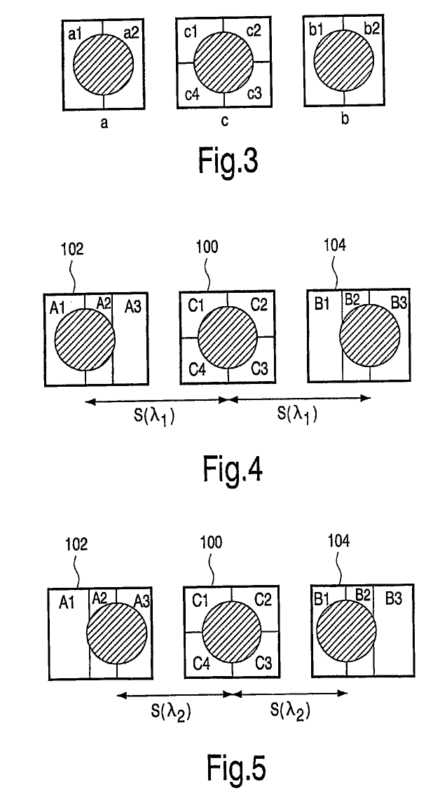

FIG. 3 is a schematic plan view of a conventional three spots push-pull tracking error detector array; and

FIGS. 4 and 5 show a schematic plan view of a detector array arranged in accordance with an embodiment of the invention;

In accordance with an embodiment of the invention, at least two formats of optical disk OD, such as the CDR(W) format and/or the DVD-RAM format are used for storing data. The CDR(W) format disk may be written and disks of both formats may be read-out by means of the optical scanning device. The disk includes an outer transparent layer covering at least one information layer. In the case of a multilayer optical disk, two or more information layers are arranged behind the cover layer, at different depths within the disk. The side of the information layer, or in the case of a multilayer disk the side of the layer furthest away from the cover layer, facing away from the transparent layer is protected from environmental influences by a protection layer. The side of the transparent layer facing the device is the disk entrance face.

Information may be stored in the information layer or layers of the optical disk in the form of optically detectable marks arranged in substantially parallel, concentric or spiral tracks. The marks may be in any optically readable form, for example in the form of pits or areas with a reflection coefficient different from their surroundings. The information layer or layers may be formed of an optically recordable material.

As shown in the embodiment of FIG. 1, the optical scanning device includes a dual-wavelength radiation source 2, including for example two semiconductor lasers, operating at two predetermined wavelengths, λ₁ and λ₂, for example λ₁=780 nm and λ₂=655 nm. The two lasers may be integrated on one substrate. Source 2 selectively emits a diverging radiation beam of one of the two wavelengths. The light path includes a path joining component 4 with the function of joining the beam paths for the two wavelengths. The joining component 4 may take the form of a diffractive element grating or a holographic element. In the case of a holographic element, the joining component 4 may also provide a pre-collimator function. This function is needed for obtaining sufficient intensity for the write mode and sufficient rim intensity for reading a DVD format disk. A diffraction grating element 6 is used for forming three separate beams, including a main, zeroth order, beam and two, first order, satellite beams, for performing three spots push-pull radial tracking. A beam splitter 8 directs the incident beam towards a folding mirror 10. Behind the folding mirror 10 lies a collimating lens 12. Before reaching the disk, the beams pass through an objective lens 14 for focusing the beams onto spots on an information layer in the disk OD. The objective lens 14 is adapted to provide spherical aberration correction for different substrate thickness of CD and DVD format disks, when being scanned using either of the two wavelengths λ₁ and λ₂.

On reflection from the disk, the beams are returned along the incident beam path until reaching beam splitter 8, which transmits the reflected beams. The beams are directed via detector lens 16 onto a photodetector array 18, which converts the optical signals into electrical signals for data read-out, focus error control and tracking error control, as will be described in further detail below. Forward sense photodiode 20 is used for accurately controlling the power of radiation source 2 during a scanning process, in particular during a writing process.

FIG. 2 shows an arrangement of three beams, namely first order satellite beams a and b and zeroth order beam c, formed by grating 6, correctly tracking tracks of the optical disk OD.

FIG. 3 shows a conventional arrangement of three spot detectors, first order spot detectors a and b each including two half detector elements, a1, a2; b1, b2, and zeroth order spot detector c including four quadrant detector elements c1, c2, c3, c4 respectively, used for detecting a push-pull radial tracking error in the three beam spots a, b and c and astigmatic focus error in the main beam spot c. The spot detectors a, b, c are arranged in the optical scanning device in a generally tangential equivalent (track-parallel) direction. Three spots push pull radial tracking uses the push pull signal of all three spots. The push pull signal of the main spot c and the two satellites a and b are described as a function of the detracking x as:
PP(c)=γmₚₚ.sin(2πx/q)
PP(a)=mₚₚ.sin(2π(x−x₀)/q)
PP(b)=mₚₚ.sin(2π(x+x₀)/q)

In the above, mₚₚ is the push pull modulation, q is the track pitch, x₀ is the ideal separation of each of the spots a and b from the central spot, generally set at q/2, by selection of the diffraction grating pitch, to maximise the signal, and γ being the diffraction efficiency, or more particularly in the case of a grating, the grating ratio.

Connections are formed in the conventional detector array to provide the radial error signal (RE) as follows:
RE=c1−c2−c3+c4−γ(a1−a2+b1−b2)

FIGS. 4 and 5 show a radiation detector array in accordance with an embodiment of the invention. The detectors are in the form of photodiode elements forming separate spot detectors, each spot detector being separated into detector elements separated by separation lines providing desired signal separations.

The arrangement in this embodiment includes three spot detectors 100, 102, 104 arranged generally in a line, which is in a substantially track-tangential equivalent direction in the director array. A central spot detector 100 includes four rectangular detector elements C1 to C4, arranged side by side in a quadrant and separated by perpendicular separation lines, to detect the location and shape of a main, zeroth order spot. Satellite spot detectors 102 and 104 each comprise three detector elements, A1, A2, A3 and C1, C2, C3 respectively, separated by two separation lines arranged in the track-tangential equivalent direction. Detectors 102, 104 detect first order satellite spots. Spot detectors 100, 102, 104 are arranged to conduct three spot push pull radial tracking error and astigmatic focus error detection in a similar manner as that described in the prior art, but for each of two groups of beams of the first and second wavelength, λ₁ and λ₂, respectively.

All detector elements of all spot detectors supply an output signal and these signal are supplied to an electronic processing circuit, wherein the output signals are combined and processed to a read-out signal, a focus error signal and a tracking error signal.

Connections are formed in the detector array of this embodiment to provide a radial error signal (RE) as follows:
For λ₁ RE=C1−C2−C3+C4−γ1(A1+A2−A3+B1+B2−B3)
For λ₂ RE=C1−C2−C3+C4−γ2(A1−A2−A3+B1−B2−B3)

In the above, γ1 and γ2 are the grating ratios (power ratio main spot w.r.t satellite) for the two wavelengths. They both depend on the depth of the profile of the three spots grating 6. The tracking error processing circuitry is adapted to compensate for the feature that typically γ1 is not equal to γ2.

Note that in the processing circuit the output signals of detector elements A2 and A3 and those of elements B1 and B2 are added for λ₁, whilst for λ2 the output signals of detector elements A1 and A2 and those of elements B2 and B3 are added.

Note that only one three spots grating 6 is used for generating the groups of beams at each of the two wavelengths. A different diffraction angle is created at the different wavelengths. Because of the difference in wavelength the correct distance(s) of the main spot to the satellite spots on the disk and the detector array is different for λ₁ and λ₂, as follows:

$$s ( {λ}_{1} ) = \frac{{λ}_{1}}{{λ}_{2}} \cdot s ( {λ}_{2} )$$

Note that the satellite spot detectors 102, 104 are split into three parts, rather than the conventional two part satellite spot detectors used for three spots radial push-pull tracking error detection. All three elements of the two detectors A1, A2, A3 and B1, B2, B3 are used to detect the radial tracking error signal at each of the two wavelengths. However, the output from the central detector elements A2 and B2 is switched in dependence on the wavelength currently being used for scanning.

FIG. 4 illustrates the positioning of the zeroth order spot and the two first order spots on the detector elements 100, 102, 104 when the first wavelength λ₁ (the longer wavelength) is used for scanning, and when tracking is correct. In this correct tracking configuration, the satellite spots are each respectively centred on the separation lines between the central detector elements A2 and B2 and the outer detector elements A1 and B3 furthest away from the zeroth order spot detector 100. The zeroth order spot, meanwhile is centred on the central separation line separating detector elements C1 and C2 and detector elements C4 and C3, respectively. The distance between this central separation line in zeroth order detector element 100 and the outermost separation lines in the satellite spot detectors 102, 104, is set at the correct spot separation at the first wavelength, s(λ₁), as shown in FIG. 4.

FIG. 5 illustrates the positioning of the zeroth order spot and the two first order spots on the detector elements 100, 102, 104 when the second wavelength λ₂ is used for scanning, and when tracking is correct. In this correct tracking configuration, the satellite spots are each respectively centred on the separation lines between the central detector elements A2 and B2 and the outer detector elements A3 and B1 closest to the zeroth order spot detector 100. The zeroth order spot, meanwhile is centred on the central separation line separating detector elements C1 and C2 and detector elements C4 and C3, respectively. The distance between this central separation line in zeroth order detector element 100 and the outermost separation lines in the satellite spot detectors 102, 104, is set at the correct spot separation at the second wavelength, s(λ₂), as shown in FIG. 5.

Note that the central detector element A2, B2 of each of the satellite spot detectors 102, 104 is of a smaller area than each of the outward detector elements A1, A2 and B1, B3. This is because the wavelength variation (from 780 (λ₁) to 655 (λ₂) nm) is relatively small; if a greater wavelength variation is employed, this may not be the case.

Note that the optimum spot separation for CDR(W), thus for λ₁, is 0.8 μm, whilst for DVD-RAM, thus for λ₂ the optimum spot separation is 0.74 μm.

In one embodiment the distance of the satellite spots w.r.t the track is adjusted in such a way that it is optimal for 650 nm, i.e. s(λ₁)=0.88 μm and s(λ₂)=0.74 μm (±0.2 μm) because this is most critical for DVD. A typical set of signal levels, compared to the optimum, is as follows:

| | |
|---|---|
| CDR(W) | 97% |
| DVD-RAM | 100% |

In another embodiment, the distance is adjusted between the optimum for DVD and CD i.e. s(λ₁)=0.84 μm (±0.2 μm) and s(λ₂)=0.70 μm (±0.2 μm). In this embodiment the signal levels are as follows:

| | |
|---|---|
| CDR(W) | 99% |
| DVD-RAM | 99% |

Note that, in each of these embodiments, the correct tracking spots distance ratio, and hence the detector spacing ratio s(λ₁):s(λ₂) is set at approximately 780:655.

The invention is applicable to DVD/CDR(W) combined scanning devices, DVD-ROM/CD combined scanning devices, for DVD-RAM/CDR(W) Double Writer scanning devices, and to various combinations thereof.

The above embodiments are to be understood as illustrative examples of the invention. Further embodiments of the invention are envisaged. For example, instead of or in addition to detecting the first order satellite spots, second order satellite spots may be detected using detector elements similar to detector elements 102 and 104. Furthermore, the zeroth order detector may be arranged to conduct spot size focus error detection instead of astigmatic focus error detection. It is to be understood that any feature described in relation to one embodiment may also be used in other of the embodiments. Furthermore, equivalents and modifications not described above may also be employed without departing from the scope of the invention, which is defined in the accompanying claims.

1. A radiation detector array for radial tracking error detection when scanning optical record carrier with any one of two different wavelengths, said array comprising a plurality of spot detectors for detecting first and second groups of radiation beams forming respectively first and second sets of spots corresponding to different diffractive orders including a zeroth order and an n^{th} order, n being an integer of 1 or more, each said spot detector being arranged to detect a characteristic of a spot formed by a said beam and each said spot detector comprising a plurality of detector elements for detecting different parts of a said spot, said array comprising a zeroth order spot detector arranged substantially centrally and n^{th} order spot detectors arranged to each side thereof, characterized in that said n^{th} order spot detectors are arranged to perform radial tracking error detection for a first set of spots in which the n^{th} order spots have a first predetermined spacing characteristic with respect to the zeroth order spot and for a second set of spots in which the n^{th} order spots have a second, different predetermined spacing characteristic with respect to the zeroth order spot.

2. A radiation detector array according to claim 1, wherein said n^{th} order spot detectors are arranged to perform push-pull radial tracking error detection.

3. A radiation detector array according to claim 1, wherein said n^{th} order spot detectors each comprise a plurality of detector elements separated by separation means, said separation means comprising a first separation means defining said first spacing characteristic and a second separation means defining said second spacing characteristic.

4. A radiation detector array according to claim 3, wherein said first separation means and said second separation means are arranged to each side of a central detector element used for detecting both said first set of n^{th} order spots and said second set of n^{th} order spots.

5. A radiation detector array according to claim 4, wherein said n^{th} order spot detectors each comprise three detector elements, including said central detector element and outer detector elements arranged to each side thereof.

6. A radiation detector array according to claim 5, wherein all three detector elements are used for detecting both said first set of n^{th} order spots and said second set of n^{th} order spots.

7. A radiation detector array according to claim 5, wherein said detector elements have detecting surface widths measured perpendicular to said separation means, and wherein said outer detector elements each have a greater detecting surface width than said central detector element.

8. A radiation detector array according to claim 1, wherein said zeroth order spot detector is arranged to detect a push pull radial tracking error for both said first set of spots and said second set of spots.

9. A radiation detector array according to claim 1, wherein said zeroth order spot detector is arranged to detect a focus error for both said first set of spots and said second set of spots.

10. A radiation detector array according to claim 1, wherein said first and second spacing characteristics have a ratio of approximately 780:655.

11. A dual optical scanning device, using two wavelengths, comprising a radiation detector array according to claim 1.

12. A dual optical scanning device according to claim 11, said device comprising a diffraction component for generating both said first group of radiation beams and said second group of radiation beams.

13. A dual optical scanning device according to claim 11, comprising radiation source means for generating radiation of a first predetermined wavelength, of which said first group of radiation beams is formed, and a second predetermined wavelength, of which said second group of radiation beams is formed.

14. An optical scanning device according to claim 13, wherein said first and second spacing characteristics have a ratio corresponding approximately to the ratio of the first and second wavelengths.
